(19) United States
(12) Patent Application Publication
(10) Pub. No.: US 2025/0214452 A1
(43) Pub. Date: Jul. 3, 2025

(54) POWER TRANSMISSION STRUCTURE FOR VEHICLE

(71) Applicant: KANZAKI KOKYUKOKI MFG. CO., LTD., Amagasaki-shi (JP)

(72) Inventors: Koji KIYOOKA, Amagasaki-shi (JP); Jun MATSUURA, Amagasaki-shi (JP); Mai TERADA, Amagasaki-shi (JP)

(21) Appl. No.: 18/983,913

(22) Filed: Dec. 17, 2024

(30) Foreign Application Priority Data
Dec. 27, 2023 (JP) 2023-221394

(51) Int. Cl. B60L 15/20

(52) U.S. Cl. CPC B60L 15/2054; B60L 2200/40; B60L 2240/461; B60L 2240/48; B60L 2240/50; B60L 2250/24

(57) ABSTRACT

[Problem] To provide a power transmission structure for a vehicle capable of further reliably preventing switching from a clutch engaged state to a clutch disengaged state. [Solution] The power transmission structure includes: a gear fitted to an axle in a relatively rotatable manner; a clutch sleeve fitted to the axle in a manner not to rotate relative thereto and be freely slidable in an axial direction; and a lever member that moves the clutch sleeve, and switches to enable or disable power transmission between the gear and the axle by movement of the clutch sleeve. The lever member is rotatable about a first rotation axis and has a locking lever and a locked section provided to the locking lever and locked to a locking groove of the clutch sleeve. A reference imaginary plane that includes an axle parallel line starting from the first rotation axis is defined. When the lever member swings in a first direction about the first rotation axis, a position, which is closest to a wall surface on the gear side of the locking groove, in the locked section is made to be located away from the reference imaginary plane in the first direction, thereby resulting in the clutch engaged state.

### CROSS REFERENCE TO RELATED APPLICATIONS

The present invention claims priority under 35 U.S.C. § 119 to Japanese Application No. 2023-221394 filed Dec. 27, 2023, the entire content of which is incorporated herein by reference

### TECHNICAL FIELD

The present invention relates to a power transmission structure for a vehicle.

### BACKGROUND ART

Conventionally, it has been known that a vehicle such as a lawn mowing vehicle can travel by using an electric motor to drive wheels. The lawn mowing vehicle includes a work unit such as a lawn mower. A lawn mowing vehicle in which left and right wheels are driven by a common electric motor is described in Patent Document 1. The following lawn mowing vehicle is described in Patent Document 2. In the lawn mowing vehicle, left and right wheels can be driven independently of each other, the left wheel is driven by a left electric motor, and the right wheel is driven by a right electric motor.

### PRIOR ART DOCUMENT

### Patent Document

Patent Document 1: U.S. Patent Application Publication No. 2009/0069964
Patent Document 2: Japanese Unexamined Patent Application Publication No. 2014-117026

### SUMMARY OF INVENTION

### Technical Problem

In the vehicle in which the left and right wheels are driven by one or two motors as described above, a power transmission structure is used to transmit power of the electric motor(s) to the wheels. In this case, it is also considered to use, instead of the electric motor, another power source in which an engine and a hydraulic transmission or the like are combined.

By the way, there is a market demand for a vehicle as follows. The vehicle can be moved with a small force by towing or the like even in the case where stationary torque of the power source is high during off of a system electric power source of the vehicle, such as a case where cogging torque of the electric motor is high. To handle such a demand, it is considered to provide a manually-controllable clutch that is referred to as a towing clutch and can enable or disable power transmission through a power transmission path connecting an axle and a gear mechanism.

Such a power transmission structure having the clutch is requested that switching of the clutch into a clutch disengaged state is reliably prevented unless a driver performs a clutch operation in a clutch engaged state. For example, in the case where the vehicle is stopped on a slope while the clutch is engaged, and the clutch is unexpectedly disengaged for some reason without the clutch operation by the driver, the vehicle may move down on the slope without resistance by the power source, or the like. In particular, when weight of the vehicle is increased, a possibility of occurrence of such inconvenience is increased.

The present invention provides a power transmission structure for a vehicle capable of further reliably preventing switching from a clutch engaged state, where power can be transmitted between a gear and an axle, to a clutch disengaged state, where power transmission is blocked, when a driver does not perform a clutch operation.

### Solution to Problem

A power transmission structure for a vehicle according to the present invention includes: an axle that directly or indirectly drives a ground wheel; a gear that is fitted to a radially outer side of the axle in a relatively rotatable manner and receives power used to drive the ground wheel; a clutch sleeve that is adjacent to the gear and is fitted to the axle in a manner not to rotate relative thereto and to be freely slidable in an axial direction; a lever member that causes the clutch sleeve to reciprocate in the axial direction. The power transmission structure for a vehicle is provided with a hole and a convex section as meshing elements capable of meshing with each other between opposing surfaces of the gear and the clutch sleeve, and switches to enable or disable power transmission between the gear and the axle by movement of the clutch sleeve. A locking groove is formed on an entire circumference of an outer circumferential surface of the clutch sleeve. The lever member includes a lever shaft, a locking lever, and a locked section, the lever shaft can rotate about a first rotation axis, which is orthogonal to an axle parallel line parallel to a center axis of the axle, and is fixed with an operation device, the locking lever is provided in one end portion of the lever shaft and extends in a direction orthogonal to the first rotation axis, and the locked section is provided at a position away from the first rotation axis of the locking lever and is locked to the locking groove. A reference imaginary plane that includes the axle parallel line starting from the first rotation axis is defined. When the lever member swings in a first direction about the first rotation axis, a position, which is closest to a wall surface on the gear side of the locking groove, in the locked section is made to be located away from the reference imaginary plane in the first direction, thereby resulting in a clutch engagement state in which the clutch sleeve can mesh with the gear via the meshing element. When the lever member swings in a second direction about the first rotation axis, the position closest to the wall surface in the locked section is made to be located away from the reference imaginary plane in the second direction, thereby resulting in a clutch disengaged state where the clutch sleeve separates from the gear in the axial direction.

### Advantageous Effects of Invention

According to the power transmission structure for a vehicle according to the present invention, it is possible to further reliably prevent switching from the clutch engaged state to the clutch disengaged state when a driver does not perform a clutch operation.

### BRIEF DESCRIPTION OF DRAWINGS

FIG. 1 is a perspective view of a vehicle on which a power transmission structure for a vehicle according to an embodiment of the invention is mounted.

FIG. 2 is a schematic configuration view of the vehicle in FIG. 1 that is seen from above.

FIG. 3 is an enlarged view of two left and right power transmission structures on a rear side that are illustrated in FIG. 2 and seen from above.

FIG. 4 is a perspective view of the left power transmission structure for a left wheel that is taken out from FIG. 3 and seen from above.

FIG. 5 is a transverse cross-sectional view of the power transmission structure illustrated in FIG. 4.

FIG. 6 is an enlarged cross-sectional view that is taken along A-A in FIG. 5.

FIG. 7A is a view illustrating a clutch engaged state of an upper portion of FIG. 6.

FIG. 7B is a cross-sectional view that is taken along B-B in FIG. 7A.

FIG. 7C is an enlarged view of a part of FIG. 7B.

FIG. 8A is a view illustrating a clutch disengaged state and corresponding FIG. 7A.

FIG. 8B is a cross-sectional view that is taken along C-C in FIG. 8A.

FIG. 8C is an enlarged view of a part of FIG. 8B.

FIG. 9 is a view illustrating a relationship between shaft spline grooves and clutch spline grooves in a section D of FIG. 6 and is a view in which a circumferential direction of an axle and a clutch sleeve is stretched on a plane.

FIG. 10 includes views that correspond to FIG. 9 when the clutch engaged state is switched to the clutch disengaged state in the embodiment.

FIG. 11 is a view that is seen in an arrow E direction in FIG. 4.

FIG. 12 is a cross-sectional view that is taken along F-F in FIG. 11.

FIG. 13 is a cross-sectional view that is taken along H-H in FIG. 12.

FIG. 14 is a view in which a left portion of FIG. 11 is seen in the same direction as that in FIG. 11 and is a view illustrating a state where a brake case is removed from an outer case.

FIG. 15 is a cross-sectional view that is taken along I-I in FIG. 11.

FIG. 16A is a perspective view in which a structure of assembling a brake shaft, a brake lever, and a movable brake pad to a brake case is taken out from FIG. 4 and is seen from a motor side.

FIG. 16B is a view illustrating the right power transmission structure and corresponding to FIG. 16A.

FIG. 17A is a cross-sectional view of parts of an output gear and a clutch sleeve in a circumferential direction and is a view illustrating a clutch disengaged state of a power transmission structure for a vehicle in another example of the embodiment according to the invention.

FIG. 17B (a) is a view illustrating a side surface of an upper half portion of the clutch sleeve on the output gear side in the other example of the embodiment, and FIG. 17B (b) is a cross-sectional view that is taken along K-K in (a).

FIG. 18A is a cross-sectional view of parts of an output gear and a clutch sleeve in the circumferential direction and is a view illustrating a clutch disengaged state of a power transmission structure for a vehicle in further another example of the embodiment according to the invention.

FIG. 18B (a) is a view illustrating a side surface of an upper half portion of the clutch sleeve on the output gear side in further another example of the embodiment, and FIG. 18B (b) is a cross-sectional view that is taken along M-M in (a).

FIG. 19 is a view illustrating switching action from the clutch disengaged state to the clutch engaged state when a clutch sleeve rotates to one side in the circumferential direction with respect to an output gear at an initial switching stage to the clutch engaged state in further another example of the embodiment and is a view corresponding to FIG. 18A.

FIG. 20 is a view illustrating switching action from the clutch disengaged state to the clutch engaged state when the clutch sleeve rotates to the other side in the circumferential direction with respect to the output gear at the initial switching stage to the clutch engaged state in further another example of the embodiment and is a view corresponding to FIG. 18A.

### DESCRIPTION OF EMBODIMENTS

Hereinafter, a detailed description will be made on embodiments of the present invention with reference to the drawings. Hereinafter, a description will be made on a case where a power transmission structure for a vehicle is mounted on a lawn mowing vehicle as a work vehicle. However, the vehicle on which the power transmission structure for the vehicle is mounted is not limited thereto. The vehicle may be another work vehicle that has a work unit performing at least one of snow removal work, excavation work, construction work, and agricultural work, or may be an off-road utility vehicle that has a loading platform and travels on an uneven terrain. Alternatively, the vehicle may be an all-terrain vehicle (ATV) called a buggy, a recreational vehicle (RV), or a recreational off-highway vehicle (ROV). In addition, hereinafter, a description will be made on a case where two rear wheels of the vehicle are driven by two motors. However, the vehicle may be configured that two front wheels are driven by the two motors. Furthermore, hereinafter, a description will be made on a case where left and right lever-type operation units having two left and right operation levers are used. However, this is merely illustrative. A steering wheel may be used as a turn instruction device, and an accelerator pedal provided in front of a seat may be used as a travel instruction device. Hereinafter, the same components will be denoted by the same reference signs in all of the drawings, and the overlapping description will not be made or will be simplified.

### First Embodiment

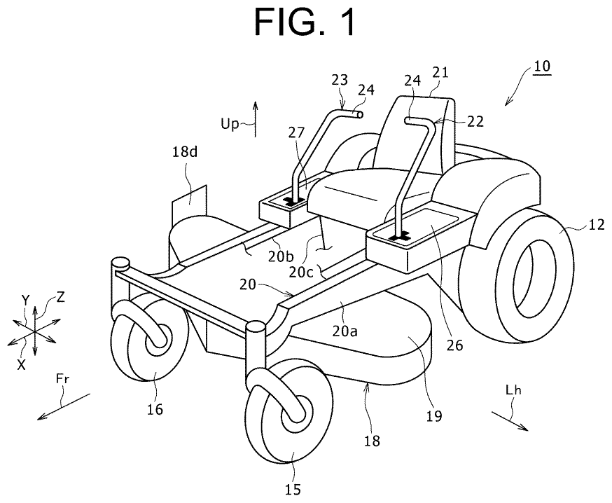

FIGS. 1 to FIG. 16B illustrate a first embodiment. In the drawings, which will be described below, a front-rear direction is indicated as an X-direction, a left-right direction is indicated as a Y-direction, and an up-down direction is indicated as a Z-direction. A front direction is indicated by Fr, a left direction is indicated by Lh, and an up direction is indicated by Up. The X-direction, the Y-direction, and the Z-direction are orthogonal to each other.

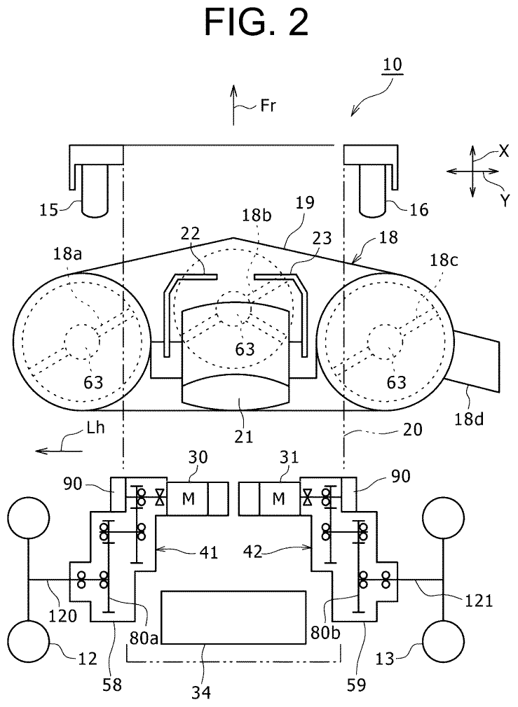

FIG. 1 is a perspective view of a vehicle 10 to which a power transmission structure for a vehicle in the embodiment is assembled. FIG. 2 is a schematic configuration view of the vehicle 10. In the following description, the power transmission structure for the vehicle will be described as a power transmission structure. The vehicle 10 is a passenger, self-propelled lawn mowing vehicle suitable for lawn mowing. The vehicle 10 includes: two left and right wheels that are a left wheel 12 and a right wheel 13 (FIG. 2); caster wheels 15, 16 as two left and right front wheels; a lawn mower 18 as a work unit; and a left travel motor 30 and a right travel motor 31 (FIG. 2). The left wheel 12 and the right wheel 13 correspond to ground wheels. The vehicle 10 also includes: three deck motors 63 (FIG. 2) as work motors; two left and right operation levers 22, 23; a battery 34 (FIG. 2); and a controller (not illustrated). Each of the left travel motor 30, the right travel motor 31, and the deck motors 63 is an electric motor. The left travel motor 30 and the right travel motor 31 correspond to power sources.

The left wheel 12 and the right wheel 13 are rear wheels that are respectively supported on left and right sides of a rear portion of a main frame 20 as a vehicle body and are main drive wheels. The main frame 20 is formed of metal, such as a steel material, into a beam structure or the like. The main frame 20 includes: side plate sections 20a, 20b that respectively extend in the substantially front-rear direction at left and right ends; and a coupling section 20c that couples the side plate sections 20a, 20b on the left and right sides. A driver's seat 21, on which a driver is seated, is fixed onto top of a portion between rear end portions of the left and right side plate sections 20a, 20b.

The left and right operation levers 22, 23 are separately arranged on left and right sides of the driver's seat 21 and move in the front-rear direction to instruct rotational directions and rotational speeds of the left wheel 12 and the right wheel 13, respectively. More specifically, in the main frame 20, two guide panels 26, 27 are fixed to the left and right sides of the driver's seat 21 and are supported on the main frame 20 such that the two left and right operation levers 22, 23 protrude upward from the two guide panels 26, 27, respectively. The left operation lever 22 corresponds to a travel instruction device that instructs acceleration/deceleration, stop, and forward/reverse rotation of the left travel motor 30. The right operation lever 23 corresponds to a travel instruction device that instructs acceleration/deceleration, stop, and forward/reverse rotation of the right travel motor 31. Tip portions of the operation levers 22, 23 are gripped by the user to instruct the rotational directions and the rotational speeds of the left wheel 12 and the right wheel 13, respectively. The left operation lever 22 is operated to instruct driving (speed adjustment) or the stop of the left wheel 12. The right operation lever 23 is operated to instruct driving (speed adjustment) or the stop of the right wheel 13.

Each of the operation levers 22, 23 is substantially L-shaped and is formed with a grip section 24 in an upper end portion. The grip section 24 extends to protrude in the left-right direction. The left and right grip sections 24 are gripped and operated by the driver's hands. A lower end portion of each of the operation levers 22, 23 extends to an inner side of a riding floor, and is pivotally supported by a shaft (not illustrated) that is fixed to the main frame 20 along the left-right direction. The grip section 24 is swingable in the front-rear direction about this shaft. When being tilted forward, the operation lever 22 (or 23) instructs the travel motor 30 (or 31) on the same side to be driven at a target rotational frequency per unit time (sec-1), which is a target rotational speed corresponding to a forward travel operation, according to a degree of the tilt with an N position, which is a neutral position near an upright position, being a reference. A target rotational frequency per minute (min-1) may be set as the target rotational speed.

Each of the operation levers 22, 23 instructs to increase the target rotational frequency as the degree of the tilt thereof is increased. When being tilted rearward with the N position being the reference, the operation lever 22 (or 23) instructs the travel motor 30 (or 31) on the same side to increase the target rotational frequency as the degree of the tilt thereof in a backward travel operation direction is increased. When being moved to the N position, the operation lever 22 (or 23) instructs to stop driving of the travel motor 30 (or 31) on the same side. In this way, when being operated by the driver, the operation levers 22, 23 respectively instruct the target rotational frequencies of the travel motors 30, 31 and thereby instruct forward travel, backward travel, turning, or the stop of the vehicle.

Tilt angles in the front-rear direction of the two left and right operation levers 22, 23 are detected by left and right lever position sensors (not illustrated), respectively. An example of the lever position sensor includes a potentiometer. A detection signal of each of the lever position sensors is sent to the controller.

The two left and right caster wheels 15, 16 are steered wheels that are supported on a front end portion of the main frame 20, and are the front wheels. In the front-rear direction of the vehicle 10, the caster wheels 15, 16 are provided away from the left wheel 12 and the right wheel 13 in the front-rear direction, respectively. Each of the caster wheels 15, 16 can rotate freely for 360 degrees or more about an axis in a vertical direction (the up-down direction in FIG. 1). The present invention is not limited to the configuration that the two caster wheels are arranged in the vehicle. Only one, three, or more caster wheels may be arranged in the vehicle.

As illustrated in FIG. 2, the left travel motor 30 is connected to the left wheel 12 via a left power transmission structure 41 that is supported on a rear portion of the main frame 20. The right travel motor 31 is connected to the right wheel 13 via a right power transmission structure 42 that is supported on the rear portion of the main frame 20. As will be described below, each of the power transmission structures 41, 42 has a gear mechanism and respective one of axles 120, 121, each of which is coupled to the gear mechanism, to enable power transmission. In the rear portion of the main frame 20, the left travel motor 30 and the right travel motor 31 are supported on the left side and the right side, respectively. Each of the travel motors 30, 31 is driven by a corresponding travel inverter (not illustrated). The controller controls driving of the travel inverter according to the operation of respective one of the operation levers 22, 23. In this way, the two left and right travel motors 30, 31 are respectively connected to the two left and right wheels 12, 13 and are driven independently of each other.

The battery 34 is connected to the left travel inverter (not illustrated) for driving the left travel motor 30 and to the right travel inverter (not illustrated) for driving the right travel motor 31, and the battery 34 supplies electric power thereto. Each of the left travel motor 30 and the right travel motor 31 is a three-phase motor, for example. As illustrated in FIG. 2, at a position behind the driver's seat 21, the battery 34 is fixed to an upper surface side or a lower surface side of the main frame 20.

As illustrated in FIG. 1 and FIG. 2, the lawn mower 18 is supported on a lower side of an intermediate portion in the front-rear direction of the main frame 20 in a manner to be freely lifted or lowered with respect to the ground. Accordingly, in the front-rear direction, the lawn mower 18 is arranged between a set of the caster wheels 15, 16 and a set of the left and right wheels 12, 13. The lawn mower 18 includes three lawn mowing blades 18a, 18b, 18c (FIG. 2) as rotary lawn mowing devices that are arranged inside a mower deck 19 as a cover. The mower deck 19 covers the lawn mowing blades 18a, 18b, 18c from above. Each of the lawn mowing blades 18a, 18b, 18c has plural blade elements, each of which rotates about a shaft oriented in the vertical direction (a sheet front-back direction of FIG. 2). Thus, the blade elements rotate with the shaft and thus can mow lawns. The three deck motors 63 as the work motors are respectively connected to the shafts of the three lawn mowing blades 18a, 18b, 18c. The battery 34 is connected to each of the deck motors 63 via a deck inverter (not illustrated), which is an inverter for the respective deck motor 63, and the battery 34 supplies the electric power thereto. The controller controls driving of each of the deck inverters according to an operation of a deck switch (not illustrated). In this way, each of the deck motors 63 is driven. Each of the deck motors 63 is the three-phase motor, for example.

The lawn mower 18 may be configured to include a lawn mowing reel as a rotary lawn mowing device. The lawn mowing reel has a function to mow the lawn or the like by arranging a spiral blade on a rotational shaft that is parallel to a ground surface, for example. The lawn mowing reel is driven by an electric motor that is coupled to an end of the rotational shaft.

Furthermore, each of the two operation levers 22, 23 is configured that an outward tilt thereof in a vehicle width direction from an upright neutral state can also be retained, and a position at which the tilt thereof is retained is set as a parking brake position. Each of the two operation levers 22, 23 has a function to instruct actuation of a brake mechanism 90, which will be described below, as a parking brake when being moved to the parking brake position. A T-shaped guide hole is formed in each of the guide panels 26, 27 that are provided in an upper portion of the vehicle. In this way, the two operation levers 22, 23 can be opened outward in the vehicle width direction only from the upright neutral states of the operation levers 22, 23. Each of the left and right operation levers 22, 23 can be coupled to the brake mechanism 90 either mechanically or electrically via a link mechanism. When both of the operation levers 22, 23 are opened outward, the brake mechanism 90 is actuated, and the left wheel 12 and the right wheel 13 are braked.

What have been described so far is the overall configuration of the vehicle 10. Next, a description will be made on the power transmission structures 41, 42 (FIG. 2) mounted on this vehicle 10. The axle 120, which is provided to the left power transmission structure 41, is connected to the left wheel 12 directly or indirectly. The axle 121, which is provided to the right power transmission structure 42, is connected to the right wheel 13 directly or indirectly. In this way, the left and right wheels 12, 13 are directly or indirectly driven by the left and right axles 120, 121, respectively. The right power transmission structure 42 is the same structure as the left power transmission structure 41 except for being symmetrical about a center in the vehicle width direction. For this reason, hereinafter, the left power transmission structure 41 will be described in detail. Hereinafter, the left travel motor 30 will be described as the travel motor 30.

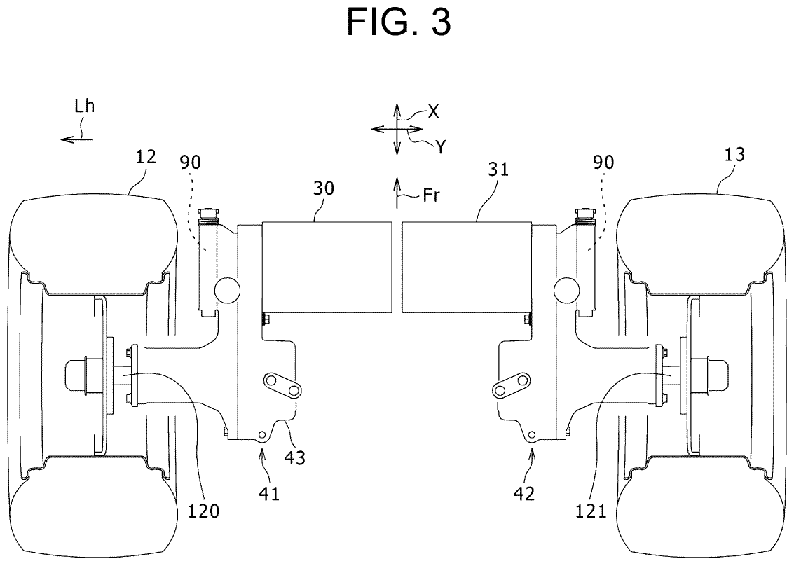

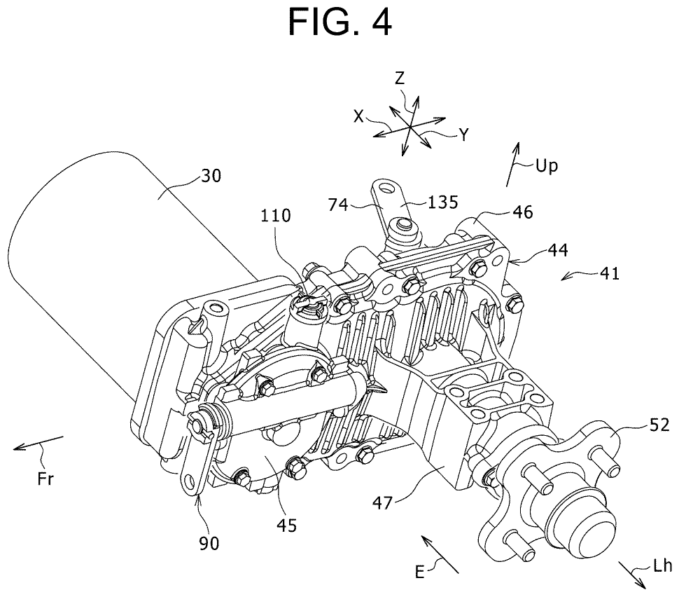

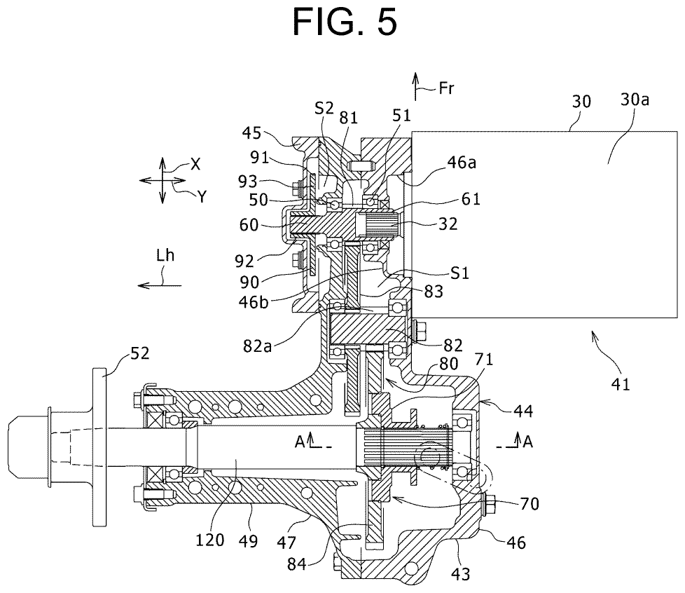

FIG. 3 is an enlarged view of the two left and right power transmission structures 41, 42 on a rear side that are illustrated in FIG. 2 and seen from above. FIG. 4 is a perspective view of the left power transmission structure 41 for the left wheel 12 that is taken out from FIG. 3 and is seen from above. FIG. 5 is a transverse cross-sectional view of the power transmission structure 41. The power transmission structure 41 is formed by integrally assembling a case 43, the travel motor 30, the gear mechanism 80 (FIG. 5), the axle 120, and the brake mechanism 90. The case 43 is formed by assembling a transmission case 44 and a brake case 45.

As illustrated in FIG. 5, an input shaft 60, the axle 120, and the gear mechanism 80 are accommodated in the transmission case 44. The gear mechanism 80 is a mechanism that transmits rotational power from the input shaft 60 to the axle 120 at a reduced speed. The input shaft 60 and the axle 120 are arranged in parallel. As will be described below, the input shaft 60 is coupled to a motor shaft 32 of the travel motor 30, and the input shaft 60 rotates in synchronization with the motor shaft 32.

The transmission case 44 is integrated by joining an inner case 46 and an outer case 47 with plural bolts. The inner case 46 forms an inner portion in the vehicle width direction (a right portion on the sheet of FIG. 5) on one side in an axial direction. The outer case 47 forms an outer portion in the vehicle width direction (a left portion on the sheet of FIG. 5) on the other side in the axial direction. Here, the axial direction of the power transmission structure 41 is a direction that is parallel to longitudinal directions of the input shaft 60 and the axle 120 and matches the vehicle width direction.

The inner case 46 is a gear case that has a concave section 46a and a concave section 46b. On the inner side in the vehicle width direction, the concave section 46a is provided in a front portion of the inner case. On the outer side in the vehicle width direction, the concave section 46b is provided from the front portion to a rear portion. The outer case 47 is opened on the inner side in the vehicle width direction, and a cylindrical section 49 extends in the axial direction from a rear portion of an outer surface in the vehicle width direction. The axle 120 penetrates this cylindrical section 49. The inner case 46 and the outer case 47 are joined to each other such that outer circumferential edges of end portions thereof in the vehicle width direction abut each other. In this way, the concave section 46b, which is located on the outer side in the vehicle width direction, in the inner case 46 is closed by the outer case 47. As a result, a gear chamber S1 is formed in the transmission case 44, and each gear of the gear mechanism 80 is arranged in the gear chamber S1. Meanwhile, the concave section 46a, which is located on the inner side in the vehicle width direction, in the transmission case 44 is closed by a motor case 30a of the travel motor 30. The motor shaft 32 of the travel motor 30 and the input shaft 60 are arranged such that axes thereof match each other. The motor shaft 32 corresponds to a rotational shaft.

As illustrated in FIG. 5, the input shaft 60 is formed with a cylindrical section 61 in a first end portion on the travel motor 30 side. A female spline section that is formed on an outer circumferential surface in a tip portion of the motor shaft 32 is engaged with a male spline section that is formed on an inner circumferential surface of the cylindrical section 61. In this way, the input shaft 60 rotates in synchronization with the motor shaft 32.

The input shaft 60, to which the travel motor 30 is coupled, has a second end portion on an opposite side of the first end portion. A brake rotor 91 that constitutes the brake mechanism 90 described below is fitted to the second end portion and is provided not to be rotatable relative to the input shaft 60. The brake case 45 is joined to the outer side of the outer case 47 in the vehicle width direction by a plurality of bolts in a manner to cover the second end portion of the input shaft 60 and the brake rotor 91. In this way, a brake chamber S2 is formed in the brake case 45. An intermediate portion of the input shaft 60 in the vehicle width direction is rotatably supported at plural positions on the transmission case 44 via bearings 50, 51.

Meanwhile, the gear mechanism 80 includes: a first helical gear 81 that is engraved on an outer surface between the first end portion and the second end portion of the input shaft 60; an intermediate gear shaft 82 that is arranged between the input shaft 60 and the axle 120 and has a second helical gear 83 locked to an outer circumferential surface thereof; and an output gear 84 that is externally fitted to the axle 120. The second helical gear 83 meshes with the first helical gear 81, and the output gear 84 meshes with teeth on one side of an intermediate gear section 82a that is engraved on an outer surface of the intermediate gear shaft 82. Internal teeth of the second helical gear 83 mesh with teeth on the other side of the intermediate gear section 82a. The intermediate gear shaft 82 and the axle 120 are each rotatably supported on the inner side of the transmission case 44 via a bearing.

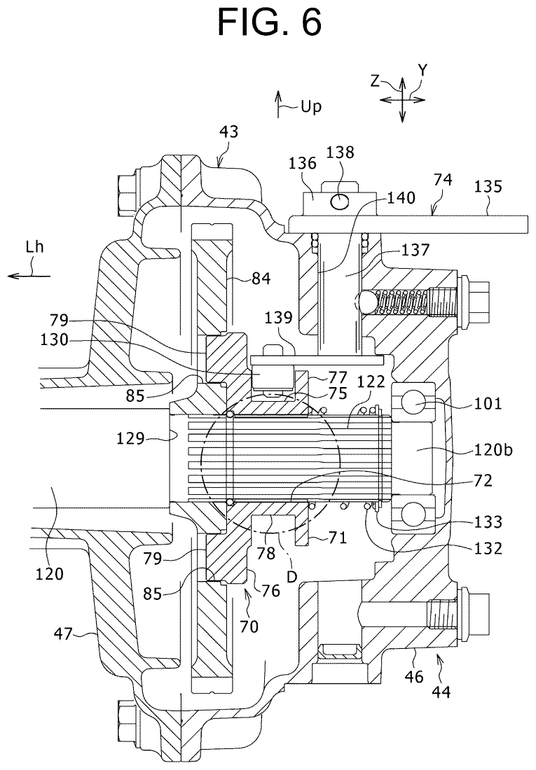

FIG. 6 is an enlarged cross-sectional view that is taken along A-A in FIG. 5. As illustrated in FIG. 5 and FIG. 6, the output gear 84 is fitted to a radially outer side of an intermediate portion of the axle 120 in a relatively rotatable manner. The output gear 84 receives power for driving the wheel 12 from the travel motor 30 via the gear mechanism 80.

As illustrated in FIG. 6, an outer end surface in the vehicle width direction near an inner circumference of the output gear 84 abuts a stepped surface 129 that is formed in the intermediate portion of the axle 120. On an outer circumferential surface of the intermediate portion of the axle 120, a clutch sleeve 71 that constitutes a clutch mechanism 70 is externally fitted to a position adjacent to an inner end in the vehicle width direction of the output gear 84.

The clutch mechanism 70 is configured to include the clutch sleeve 71, the output gear 84, the axle 120, and a lever member 74. Similar to the output gear 84 and the axle 120, the clutch sleeve 71 and the lever member 74 are accommodated in the case 43.

In an inner portion in the vehicle width direction of the axle 120, shaft spline grooves 122 as a male spline section are formed on an outer circumferential surface except for a small-diameter end portion 120b in which a diameter at an inner end in the vehicle width direction of the axle 120 is reduced. A bearing 101 for rotatably supporting the axle 120 on the inner case 46 is fitted to the small-diameter end portion 120b.

The clutch sleeve 71 is formed with clutch spline grooves 72 as a female spline section on an inner circumferential surface and is externally fitted to the axle 120. The clutch spline grooves 72 are spline-fitted to the shaft spline grooves 122 of the axle 120. In this way, the clutch sleeve 71 is fitted to the axle 120 in a manner not to rotate relative thereto and to be freely slidable in the axial direction.

The lever member 74 moves the clutch sleeve 71 to one side or the other side along the axial direction of the axle 120. Mutually-opposing surfaces of the output gear 84 and the clutch sleeve 71 are respectively formed with a convex section and a concave section as meshing elements that can mesh with each other. By movement of the clutch sleeve 71, the clutch mechanism 70 switches to enable or disable power transmission between the output gear 84 and the axle 120.

For example, when the clutch sleeve 71 is moved outward in the vehicle width direction, the clutch sleeve 71 is engaged with the output gear 84 in a manner to inhibit the relative rotation to the output gear 84, and the clutch mechanism 70 is brought into an engaged state to enable the power transmission between the output gear 84 and the axle 120. In this state, the output gear 84 and the axle 120 rotate synchronously.

Meanwhile, when the clutch sleeve 71 is moved inward in the vehicle width direction, the clutch sleeve 71 is disengaged from the output gear 84, and the clutch mechanism 70 disables the power transmission between the output gear 84 and the axle 120. In this state, the output gear 84 and the axle 120 can freely rotate relative to each other.

In the engaged state of the clutch mechanism 70, the power of the travel motor 30 is transmitted from the motor shaft 32 to the input shaft 60. The power of the input shaft 60 is decelerated by the gear mechanism 80 and is then transmitted to the axle 120 via the clutch sleeve 71. An outer end portion in the vehicle width direction of the axle 120 protrudes from a tip of the cylindrical section 49, and a hub 52 is fixed to the protruding portion. The left wheel 12 is fixed to the hub 52. In this way, in the engaged state of the clutch mechanism 70, the power of the travel motor 30 is transmitted from the motor shaft 32 to the input shaft 60, the gear mechanism 80, and the axle 120 in this order, and the left wheel 12 thereby rotates.

The travel motor 30 includes: a motor rotor that is fixed to an outer circumferential surface of the motor shaft 32; a stator core that opposes an outer circumferential surface of the motor rotor; and a three-phase stator coil that is wound around the stator core. The motor rotor has permanent magnets that are arranged at plural circumferential positions on the rotor core, for example. The stator core is fixed to the inner side of the motor case 30a. The motor shaft 32 is rotatably supported on the motor case 30a by a bearing (not illustrated). When three-phase alternating-current power is supplied to the stator coil from the battery 34, the motor shaft 32 rotates due to an interaction between a rotating magnetic field generated in the stator core and a magnetic field generated by the motor rotor.

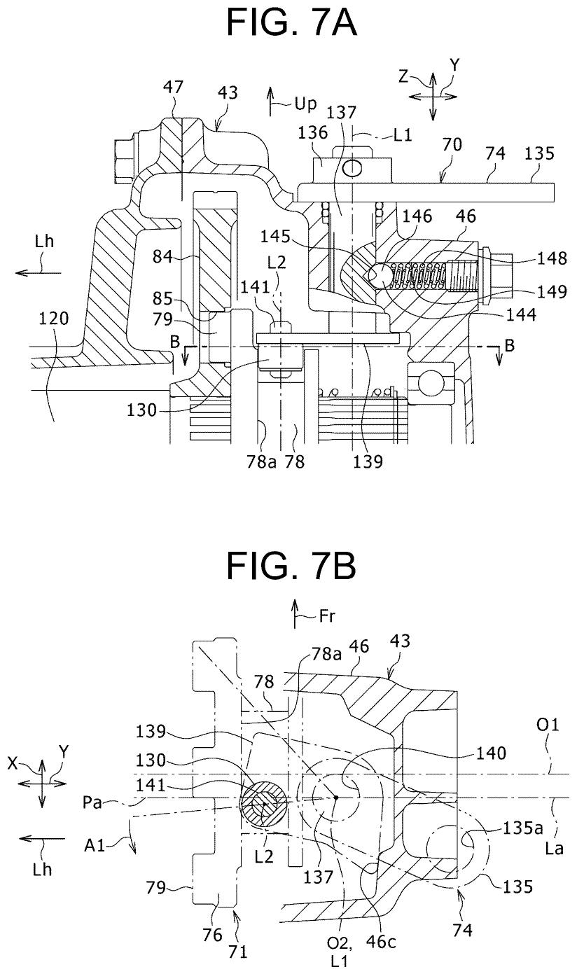

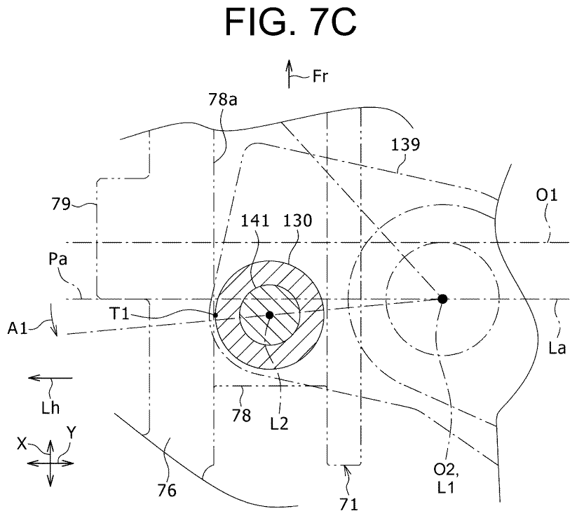

Next, the clutch mechanism 70 will be described in detail with reference to FIG. 5, FIG. 6, and FIGS. 7A to FIG. 10. FIG. 7A is a view illustrating the clutch engaged state of an upper portion of FIG. 6. FIG. 7B is a cross-sectional view that is taken along B-B in FIG. 7A. FIG. 7C is an enlarged view of a part of FIG. 7B.

The clutch sleeve 71 is configured to include: a cylindrical section 75; and a first flange 76 and a second flange 77, each of which is formed on an outer circumferential surface of a respective axial end portion of the cylindrical section 75. The first flange 76 is coupled to an outer end portion in the vehicle width direction of the cylindrical section 75. The second flange 77 is coupled to an inner end portion in the vehicle width direction of the cylindrical section 75. On an outer circumferential surface of the cylindrical section 75, a locking groove 78 is formed over an entire circumference between the first flange 76 and the second flange 77. A roller 130, which is a locked section provided to the lever member 74 described below, is locked to the locking groove 78, and the clutch sleeve 71 is moved in the axial direction by movement of the lever member 74.

A convex section 79 is formed at plural positions, which are separated at equally-spaced intervals in a circumferential direction, on an outer end surface of the first flange 76. Meanwhile, a through hole 85 is formed at plural positions in the circumferential direction of the output gear 84. The through hole 85 is a concave section that can be engaged with the convex section 79, and at each of the positions, the through hole 85 opposes the respective convex section 79.

When the clutch sleeve 71 is moved outward in the vehicle width direction with respect to the axle 120, and each of the plural convex sections 79 is engaged with the respective through hole 85, the axle 120 is connected to the output gear 84 via the clutch sleeve 71, and the clutch mechanism 70 is brought into the engaged state. Meanwhile, when the clutch sleeve 71 is moved inward in the vehicle width direction with respect to the axle 120, and each of the plural convex sections 79 is disengaged from the respective through hole 85, the state is switched to a clutch disengaged state where the axle 120 and the clutch sleeve 71 can rotate relative to each other.

An urging member 132 is provided between the clutch sleeve 71 and the axle 120. More specifically, the axle 120 has a snap ring 133 that is locked to the outer circumferential surface near the bearing 101. The urging member 132 that is externally fitted to the axle 120 is provided between the snap ring 133 and an inner end in the vehicle width direction of the clutch sleeve 71. The urging member 132 is a coil spring and elastically urges the clutch sleeve 71 in a direction to approach the output gear 84. For this reason, in the clutch mechanism 70, it is possible to reduce a required force for an operation of the lever member 74 when the lever member 74 is switched from the clutch disengaged state to the clutch engaged state.

The lever member 74 is configured to include a lever shaft 137, to which an operation tool 135 is fixed, a locking lever 139, and a roller 130 that corresponds to a locked section. The lever shaft 137 is a columnar shaft section that extends in the up-down direction. A hole 140 is formed in the up-down direction in an upper portion of the inner case 46, which constitutes the transmission case 44, in a manner to communicate with an internal space from an outer surface. As illustrated in FIG. 7B, in a top view of the inner case 46, a center line O2 of the hole 140 follows the up-down direction at a different position in the front-rear direction from a center axis O1 of the axle 120. In a state of penetrating this hole 140, the lever shaft 137 is supported on the inner case 46. In this state, the lever shaft 137 can rotate about a first rotation axis L1. The first rotation axis L1 is orthogonal to an axle parallel line La that is parallel to the center axis O1 of the axle 120 in the front-rear direction. The first rotation axis L1 matches the center line O2 of the hole 140.

The operation tool 135 is a plate section that has an oval shape in the top view and extends laterally. One end portion of the operation tool 135 is fixed to a portion of the lever shaft 137 that protrudes upward from the upper outer surface of the inner case 46. A cylindrical section 136 protrudes upward on an upper surface of the one end portion of the operation tool 135, and an upper end portion of the lever shaft 137 penetrates the cylindrical section 136. When a pin 138 laterally penetrates the cylindrical section 136 and the lever shaft 137 in this state, the operation tool 135 and the lever shaft 137 can rotate integrally. In this way, the operation tool 135 is fixed to the lever shaft 137. Meanwhile, a distal end portion of the operation tool 135 is formed with a locking hole 135a (FIG. 7B) that penetrates the operation tool 135 in the up-down direction. The operation tool 135 is coupled to a clutch switching instruction section (not illustrated), such as a lever provided near the driver's seat 21 of the vehicle, via a wire or a link (not illustrated) that is locked to the locking hole 135a.

As illustrated in FIG. 7B, the locking lever 139 has a substantially parallelogram plate shape in the top view. In the top view of the locking lever 139, a half portion on one side (a right half portion in FIG. 7B) is fixed to a lower end of the lever shaft 137 by welding, screwing, or the like. In this way, the locking lever 139 is provided to the one end portion of the lever shaft 137 and extends in a direction orthogonal to the first rotation axis L1.

In the top view of the locking lever 139, a half portion on the other side (a left half portion in FIG. 7B) is formed with a hole, which penetrates downward, on one side in a width direction. A shaft section 141 penetrates and is supported by the hole. The roller 130 is a cylindrical member that is rotatably supported at a position, which is adjacent to a lower side of the locking lever 139, on this shaft section 141. In this way, the roller 130 is provided at a position away from the first rotation axis L1 of the locking lever 139 and can rotate about a second rotation axis L2 that is parallel to the first rotation axis L1.

An outer diameter of the roller 130 substantially matches a width in the left-right direction of the locking groove 78 of the clutch sleeve 71. In a state where the lever shaft 137 penetrates and is supported by the hole 140 of the inner case 46, the roller 130 is locked to the locking groove 78.

In the case where the driver operates the clutch switching instruction section to bring the clutch mechanism 70 into the clutch engaged state where the power can be transmitted between the output gear 84 and the axle 120, the lever member 74 swings about the first rotation axis L1 in an arrow Al direction in FIG. 7B. In this case, a reference imaginary plane Pa that includes the axle parallel line La and is started from the first rotation axis L1 is defined. The clutch mechanism 70 is configured that, when the lever member 74 swings in the first direction A1 as described above, the second rotation axis L2 as a rotation center of the roller 130 is located away from the reference imaginary plane Pa in the first direction A1. In this way, the clutch mechanism 70 locates a position T1 (FIG. 7C), which is closest to a wall surface 78a of the locking groove 78 on the output gear 84 side, in the roller 130 to be away from the reference imaginary plane Pa in the first direction Al. At the position T1, the outer circumferential surface of the roller 130 is in contact with or closely opposes the wall surface 78a on the output gear 84 side of the locking groove 78. In this state, as illustrated in FIG. 7A, the clutch engaged state where the hole 85 of the output gear 84 and the convex section 79 of the clutch sleeve 71 can mesh with each other is realized. Thus, the clutch mechanism 70 is configured to be in the clutch engaged state when the lever member 74 swings in the first direction A1.

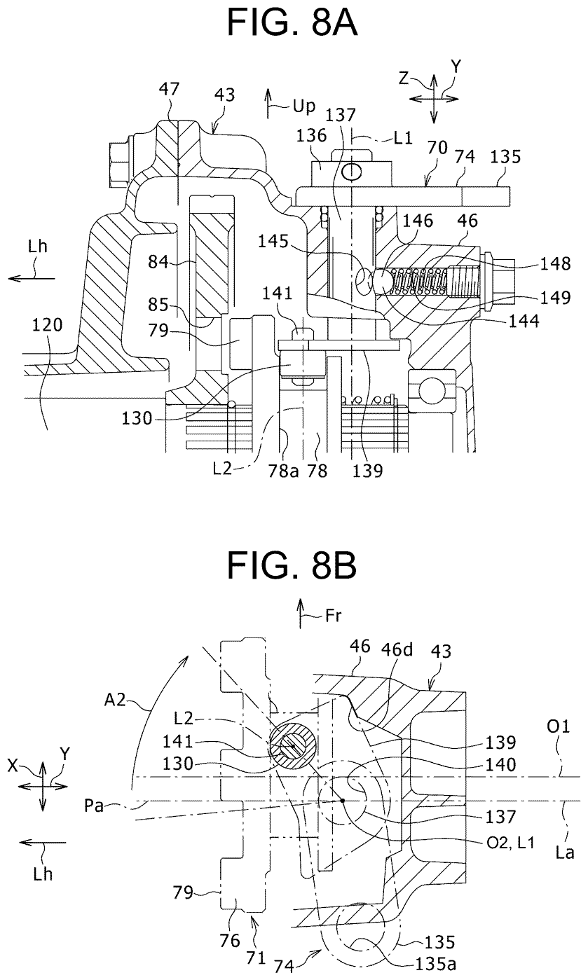

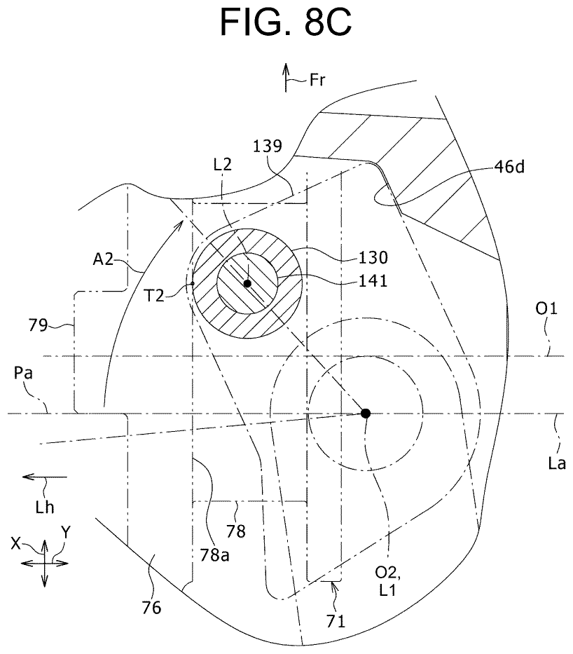

FIG. 8A is a view illustrating the clutch disengaged state and corresponding FIG. 7A. FIG. 8B is a cross-sectional view that is taken along C-C in FIG. 8A. FIG. 8C is an enlarged view of a part of FIG. 8B.

In the case where the driver operates the clutch switching instruction section to bring the clutch mechanism 70 into the clutch disengaged state where the power transmission between the output gear 84 and the axle 120 is disabled, the lever member 74 swings about the first rotation axis L1 in an arrow A2 direction in FIG. 8B. The clutch mechanism 70 is configured that, when the lever member 74 swings in the second direction A2 as described above, the second rotation axis L2 of the roller 130 is located away from the reference imaginary plane Pa in the second direction A2.

In this way, the clutch mechanism 70 locates a position T2 (FIG. 8C), which is closest to the wall surface 78a of the locking groove 78 on the output gear 84 side, in the roller 130 to be away from the reference imaginary plane Pa in the second direction A2. At the position T2, the outer circumferential surface of the roller 130 is in contact with the wall surface 78a on the output gear 84 side of the locking groove 78. In this state, as illustrated in FIG. 8A, the clutch disengaged state where the clutch sleeve 71 is away from the output gear 84 in the axial direction to cancel meshing between the hole 85 of the output gear 84 and the convex section 79 the clutch sleeve 71 is realized. Thus, the clutch mechanism 70 is configured to be in the clutch disengaged state when the lever member 74 swings in the second direction A2 as described above.

As described above, in the clutch engaged state, the position T1 (FIG. 7C), which is closest to the wall surface 78a of the locking groove 78 on the output gear 84 side, in the roller 130 is located away from the reference imaginary plane Pa in the first direction A1, that is, in a so-called over-fulcrum state. In this case, when the position, which is closest to the wall surface 78a of the locking groove 78 on the output gear 84 side, in the roller 130 is located on the reference imaginary plane Pa, the roller 130 is located at a fulcrum position, and a contact pressure between the roller 130 and the wall surface 78a is the highest. In the over-fulcrum state described above, the clutch mechanism 70 is kept in the engaged state when a pull-out load in a direction to separate the roller 130 from the fulcrum position is applied to the lever member 74. Thus, when the driver does not perform a clutch operation, the clutch engaged state is never switched to the clutch disengaged state, and thus unexpected clutch disengaged state can reliably be prevented.

In the present example, the locked section that is locked to the locking groove 78 of the lever member 74 is the roller 130 capable of rotating about the second rotation axis L2 that is parallel to the first rotation axis L1. Accordingly, friction resistance between the roller 130 and the wall surface of the clutch sleeve 71 is reduced, which hinders movement of the lever member 74 in a clutch disengagement direction.

In addition, as illustrated in FIG. 7B, a first stopper 46c that restricts the movement of the roller 130 is provided on an inner surface of the inner case 46 that constitutes the case 43. The first stopper 46c directly inhibits the movement of the lever member 74 such that, when the position T1 (FIG. 7C) of the roller 130 is located on the first direction A1 side from the reference imaginary plane Pa for the clutch engagement, the lever member 74 does not further swing in the first direction A1. In the inner case 46, the first stopper 46c is a wall surface that faces outward in the vehicle width direction on one side (a lower side in FIG. 7B) in the front-rear direction of a space where the locking lever 139 is arranged. A side surface of an end portion in a longitudinal direction of the locking lever 139 abuts the first stopper 46c. The end portion is located on an opposite side (a right side in FIG. 7B) from the support section of the roller 130. In this way, it is possible to prevent excessive swinging of the lever member 74 after the lever member 74 is brought into the over-fulcrum state.

Here, in order to prevent the lever member 74 from further swinging in the first direction A1 when the roller 130 is located on the first direction A1 side from the reference imaginary plane Pa for the clutch engagement, the case 43 may be provided with a stopper that is abutted by a member (not illustrated) supported on the lever member 74. Accordingly, it may be configured to indirectly inhibit the movement of the lever member 74 in order to prevent the lever member 74 from further swinging in the first direction A1.

Furthermore, as illustrated in FIG. 8B, a second stopper 46d that restricts the movement of the roller 130 is provided on the inner surface of the inner case 46 that constitutes the case 43. The second stopper 46d directly inhibits the movement of the lever member 74 such that, when the position T2 (FIG. 8C) of the roller 130 is located on the second direction A2 side from the reference imaginary plane Pa for the clutch disengagement, the lever member 74 does not further swing in the second direction A2. In the inner case 46, the second stopper 46d is a wall surface that faces outward in the vehicle width direction on the other side (an upper side in FIG. 8B) in the front-rear direction of the space where the locking lever 139 is arranged. A side surface of an end portion in the longitudinal direction of the locking lever 139 abuts the second stopper 46d. The end portion is located on the same side (upper side in FIG. 8B) as the support section of the roller 130 and is located on an opposite side (a right side in FIG. 8B) in a short direction from the support section of the roller 130. In this way, it is possible to prevent excessive movement of the lever member 74 in the clutch disengagement direction.

Moreover, as illustrated in FIG. 7A and FIG. 7B, a detent mechanism 144 is provided between the case 43 and the lever shaft 137. The detent mechanism 144 includes: a concave section 145 that has a conical surface shape and is formed at two circumferentially different positions in the same axial portion of the outer circumferential surface of the lever shaft 137; a ball 146 that can be engaged with one of the concave sections 145 and is arranged in a lateral hole 149 of the inner case 46; and an urging member 148 that urges the ball 146 to the lever shaft 137 side. The urging member 148 is provided between the ball 146 and a tip of a bolt that is screwed to an outer end portion of the lateral hole 149.a tip of a bolt screwed and fixed to an outer end portion of the lateral hole 149 and the ball 146. As illustrated in FIG. 7A, in the clutch engaged state, the ball 146 is engaged with one of the two concave sections 145. As illustrated in FIG. 8A, in the clutch disengaged state, the ball 146 is engaged with the other of the two concave sections 145. In this way, when the lever member 74 rotates, a rotational position of the lever member 74 can easily be kept at either a first rotational position at which the clutch engaged state is realized or a second rotational position at which the clutch disengaged state is realized.

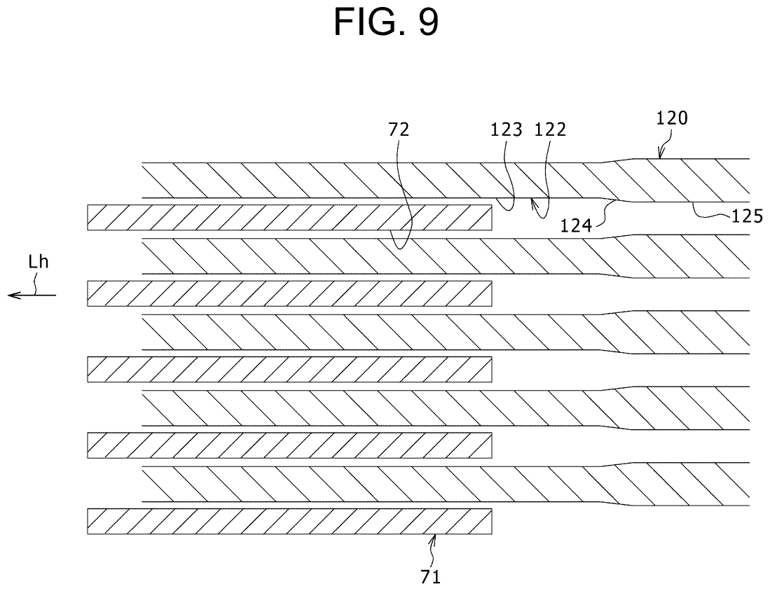

FIG. 9 is a view illustrating a relationship between the shaft spline grooves 122 and the clutch spline grooves 72 in a section D of FIG. 6 and is a view in which the circumferential direction of the axle 120 and the clutch sleeve 71 is stretched on a plane. As illustrated in FIG. 9, groove widths of the clutch spline grooves 72, which are provided on the inner circumferential surface of the clutch sleeve 71, are constant except for those near both ends in the axial direction, and groove widths of the spline grooves 72 at both of the ends on the clutch sleeve 71 side are constant.

Meanwhile, each of the shaft spline grooves 122, which are provided on the outer circumferential surface of the axle 120, has a large groove width portion 123, a reduced groove width portion 124, and a small groove width portion 125. Each of a set of the large groove width portions 123, a set of the reduced groove width portions 124, and a set of the small groove width portions 125 includes plural groove elements that are formed to extend axially at equally-spaced positions in the circumferential direction. Each of the reduced groove width portions 124 is connected to an inner (right in FIG. 9) end in the vehicle width direction of the respective large groove width portion 123, and the inner end is located on an opposite side from an end on which the output gear 84 is installed. A groove width of the reduced groove width portion 124 is reduced toward the inner side in the vehicle width direction. Each of the small groove width portions 125 is connected to an inner end in the vehicle width direction of the respective reduced groove width portion 124 and has a smaller groove width than the large groove width portion 123. A center in the circumferential direction of each of the reduced groove width portions 124 substantially matches a center in the circumferential direction of each of the large groove width portions 123, to which the respective reduced groove width portion 124 is connected.

In this way, resistance is generated when the clutch sleeve 71 is moved in the direction away from the output gear 84. That is, the clutch engaged state is not easily switched to the clutch disengaged state. As a result, it is possible to further prevent the clutch sleeve 71 from being switched from the clutch engaged state to the clutch disengaged state when the driver does not perform the clutch operation, and thus reliability is improved.

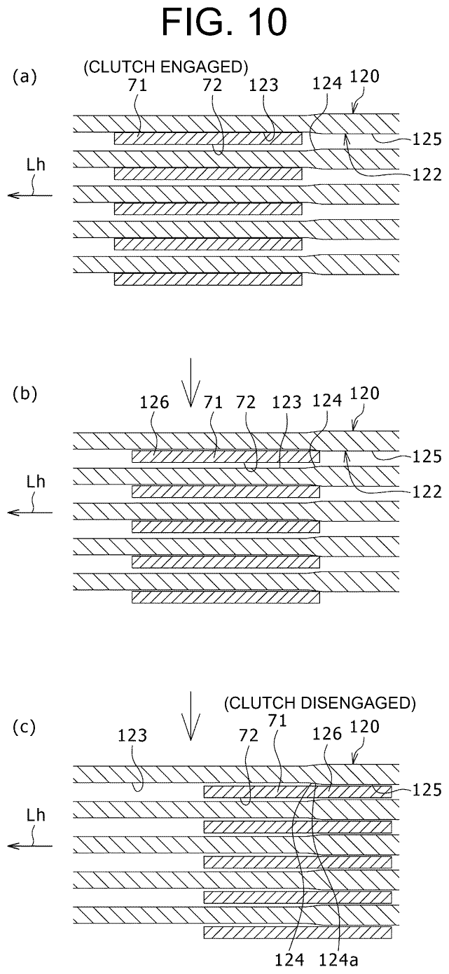

FIG. 10 includes views that correspond to FIG. 9 when the clutch engaged state is switched to the clutch disengaged state. As illustrated in FIG. 10(a), in the clutch engaged state, a gear section 126 between two each of the clutch spline grooves 72 is pressed against one side in the circumferential direction of the large groove width portion 123 of the shaft spline groove 122 during forward travel of the vehicle, and the clutch spline groove 72 is thereby engaged with the shaft spline groove 122.

When this state is switched to the clutch disengaged state, first, as illustrated in FIG. 10(b), the clutch sleeve 71 moves inward in the vehicle width direction, that is, to one side in the axial direction. Due to this movement, each of the gear sections 126 of the clutch sleeve 71 moves toward the reduced groove width portion 124 while being pressed against the one side in the circumferential direction of the large groove width portion 123 of the shaft spline groove 122. Then, as illustrated in FIG. 10(c), each of the gear sections 126 moves to the small groove width portion 125 while receiving resistance against the movement from an inclined surface 124a of the reduced groove width portion 124. The inclined surface 124a is inclined with respect to the axial direction. In this way, switching to the clutch disengaged state is unlikely to occur. Thus, it is possible to further reliably prevent switching to the clutch disengaged state when the driver does not perform the clutch operation.

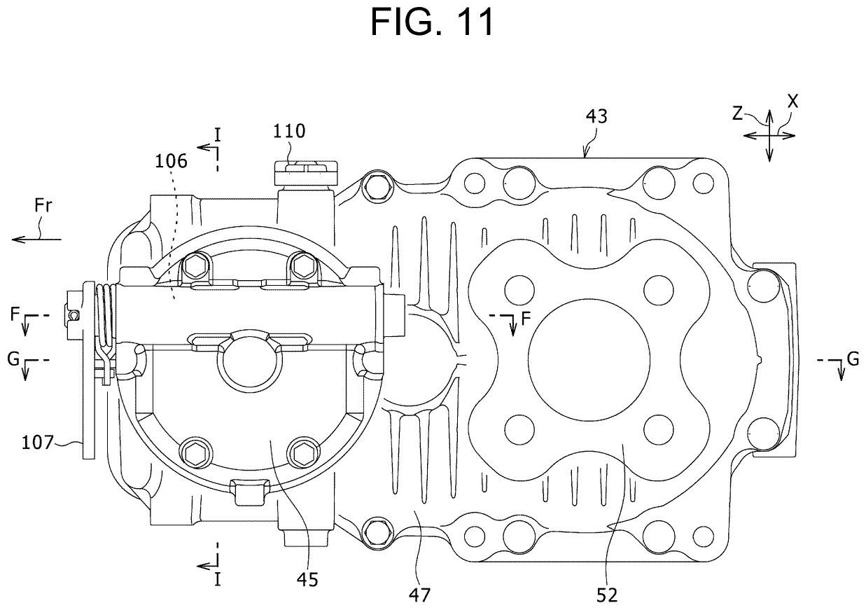

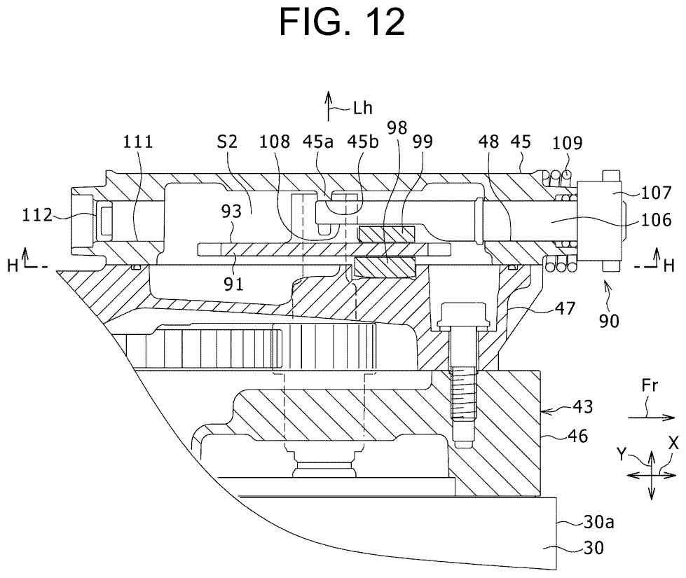

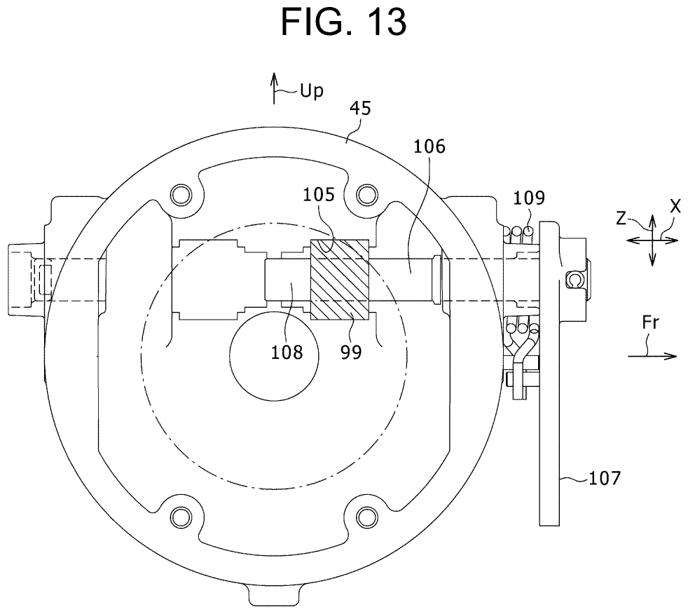

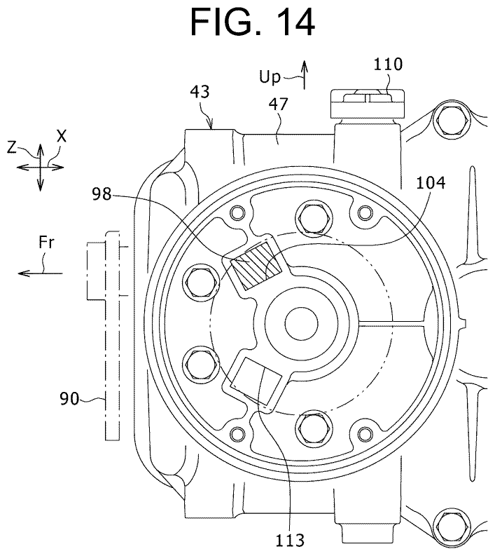

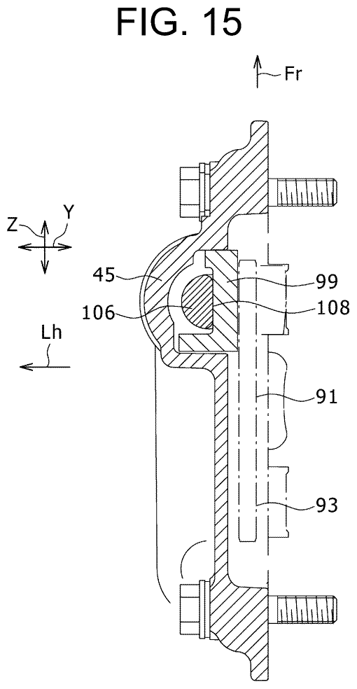

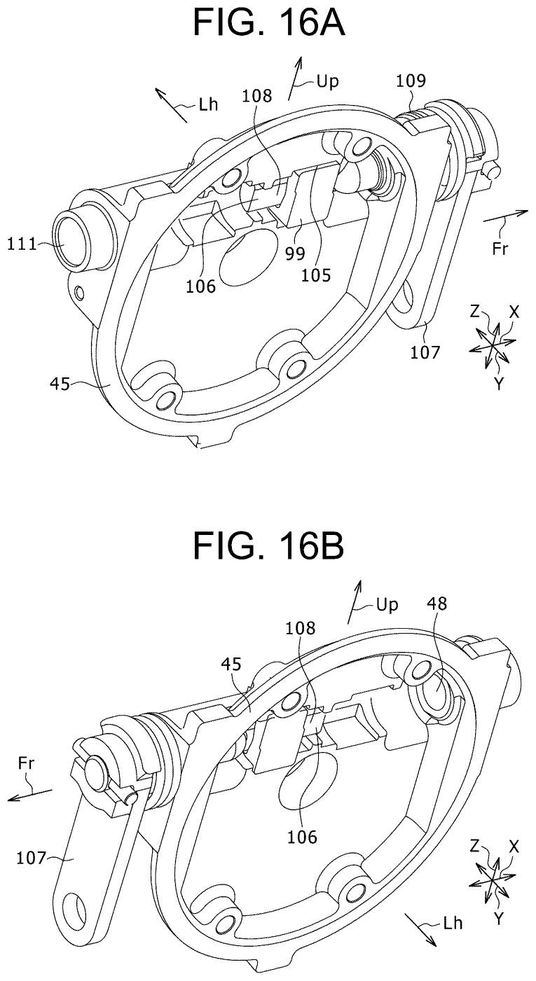

Next, a description will be made on the brake mechanism 90 with reference to FIG. 5, FIG. 11, and FIG. 16A. FIG. 11 is a view that is seen in an arrow E direction in FIG. 4. FIG. 12 is a cross-sectional view that is taken along F-F in FIG. 11. FIG. 13 is a cross-sectional view that is taken along H-H in FIG. 12. FIG. 14 is a view in which a left portion of FIG. 11 is seen in the same direction as that in FIG. 11 and is a view illustrating a state where the brake case 45 is removed from the outer case 47. FIG. 15 is a cross-sectional view that is taken along I-I in FIG. 11. FIG. 16A is a perspective view in which a structure of assembling a brake shaft, a brake lever, and a movable brake pad to the brake case 45 is removed from FIG. 4 and which is seen from the travel motor 30 side.

As illustrated in FIG. 5, as described above, the second end portion of the input shaft 60 is provided with the brake rotor 91 in a manner to prevent the relative rotation. That is, the brake rotor 91 includes: a cylindrical section 92 that is fitted to the input shaft 60; and a disc-shaped rotor body 93 that is formed at one axial end of an outer circumferential surface of the cylindrical section 92. For example, a female spline section is formed on an inner circumferential surface of the cylindrical section 92, and the female spline section is engaged with a male spline section that is formed on an outer circumferential surface of the second end portion of the input shaft 60. In this way, the brake rotor 91 rotates in synchronization with the input shaft 60.

In addition, as illustrated in FIG. 12, the brake mechanism 90 is of a mechanical type, and is configured to include: a fixed brake pad 98 and a movable brake pad 99 that are arranged to oppose side surfaces in the axial direction of the brake rotor 91; a brake shaft 106; and a brake lever 107. The brake shaft 106 is rotatably supported on an upper portion of the brake case 45 in a manner to extend in the front-rear direction. The brake lever 107 is fixed to a portion of the brake shaft 106 that is arranged outside the brake case 45.

The fixed brake pad 98 has a flat rectangular parallelepiped shape. In the outer case 47, the fixed brake pad 98 is fixed to a retaining concave section 104 (FIG. 14) in a portion of one side surface (a lower surface in FIG. 12) of a rotor body 93. The portion opposes an upper front portion of the outer case 47.

Meanwhile, as illustrated in FIG. 16A described below, the movable brake pad 99 has a block shape with an L-shaped cross section. In the brake case 45, a retaining concave section 105 (FIG. 13) for retaining the movable brake pad 99 is formed in a portion of the other side surface (an upper surface in FIG. 12) of the rotor body 93. The portion opposes an upper front portion of the brake case 45. The retaining concave section 105 is formed by a pair of concave sections having a rectangular cross section and opposing each other in the up-down direction. The movable brake pad 99 can move in the axial direction of the brake rotor 91 while being retained by the retaining concave section 105.

The brake shaft 106 penetrates a through hole 48 (FIG. 12) that is formed in the upper front portion of the brake case 45 to extend in the front-rear direction and is rotatably supported on the brake case 45. A tip portion of the brake shaft 106 that is arranged in a brake chamber S2 is formed with a cam section 108 having a substantially semi-circular cross section. On an inner surface of the brake case 45, a protruding section 45a is formed at a position that opposes the tip portion of the brake shaft 106, and the protruding section 45a is formed with a retaining concave section 45b that retains the tip portion of the brake shaft 106 in a manner to allow rotation thereof. At a position between the cam section 108 and the other surface of the rotor body 93, The movable brake pad 99 is retained in the retaining concave section 105 (FIG. 13) in a manner to be movable in the axial direction of the brake rotor 91.

When the two operation levers 22, 23, which are provided around the driver's seat 21, is operated to the parking brake position, the brake lever 107 rotates in a first direction. Consequently, the cam section 108, which is provided on the brake shaft 106, also rotates. Thus, the cam section 108 partially protrudes from the retaining concave section 104 and presses the movable brake pad 99 against the rotor body 93. As a result, the rotor body 93 is held between the movable brake pad 99 and the fixed brake pad 98, and thus the left wheel 12 is braked. In this case, the brake mechanism on the right wheel 13 side is also actuated in the same manner. Thus, the right wheel 13 is also braked.

Meanwhile, when the two operation levers 22, 23 are each operated to the different position from the parking brake position, the brake lever 107 rotates in a second direction. Consequently, the cam section 108 that is provided on the brake shaft 106 also rotates, and the cam section 108 moves back into the retaining concave section 105. As a result, the movable brake pad 99 moves away from the rotor body 93, and thus braking of the left wheel 12 is canceled. In this case, the brake mechanism on the right wheel 13 side is also actuated in the same manner. Thus, braking of the right wheel 13 is also canceled. In this way, the vehicle can travel.

A coil spring 109 is provided between an outer surface of the brake case 45 and the brake lever 107. The coil spring 109 urges the brake lever 107 such that the brake lever 107 rotates in the second direction.

Here, a brake pedal (not illustrated) that can be operated by the driver's foot is provided in front of the driver's seat 21 of the vehicle. When the brake pedal is operated, regenerative braking occurs in the left and right travel motors 30, 31, and the rotation of each of the travel motors 30, 31 is stopped.

In addition, as illustrated in FIG. 4, FIG. 11, and FIG. 14, an air breather device 110 is provided on top of a portion of the outer case 47 that opposes a rear portion of the brake case 45. In the outer case 47, the air breather device 110 is attached to a vertical through hole (not illustrated) that communicates with the brake chamber S2 (FIG. 5). The air breather device 110 is provided to prevent entry of a liquid, such as water, dust, and the like from above and to allow suctioning/discharge of air inside the brake chamber S2 from/to the outside of the case 43 when a lubricant in the brake chamber S2 expands. When an internal pressure of the brake chamber S2 is increased, the air is discharged to the outside of the case 43 through the air breather device 110. In this way, it is possible to prevent an excessive increase in the internal pressure.

Furthermore, as illustrated in FIG. 12 and FIG. 16A, in an upper rear portion of the brake case 45, a second through hole 111 is formed at a position that is aligned with the through hole 48 (FIG. 12) in the front portion in the front-rear direction. The second through hole 111 penetrates the brake case 45 in the front-rear direction in a manner to be symmetrical to the through hole 48 about a center in the front-rear direction. A plug 112 is attached to an outer end portion of the second through hole 111 and thereby prevents leakage of oil sealed in the brake case 45. The brake case 45 has a symmetrical shape about the center in the front-rear direction. Thus, the same brake case 45 can be used for each of the right wheel and the left wheel by reversing the front-rear direction of the components in the same structures.

FIG. 16B is a view corresponding to FIG. 16A for the right wheel 13. When the brake case 45 for the left wheel 12 is used for the right wheel, as illustrated in FIG. 16B, a plug is attached to the outer end portion of the rear through hole, and the brake shaft 106, to which the brake lever 107 is fixed, penetrates and is supported in the second through hole 111 (FIG. 16A) on the front side.

The outer case 47 and the inner case 46 each have a symmetrical shape about a center in the up-down direction. For example, as illustrated in FIG. 14, in the outer case 47, a second through hole (not illustrated) is formed at a position that is aligned with the through hole, to which the air breather device 110 is attached, in the up-down direction. Since a plug is attached to a lower end portion of the second through hole, leakage of the oil from the brake chamber is prevented.

In addition, as illustrated in FIG. 14, a second retaining concave section 113 is formed on an outer surface of the outer case 47 that is covered with the brake case 45 (FIG. 12). The second retaining concave section 113 is formed at a position that is symmetrical to the retaining concave section 104 for retaining the fixed brake pad 98 about the center in the up-down direction. Accordingly, the same outer case 47 and the same inner case 46 can be used for each of the right wheel and the left wheel by reversing the up-down direction of the components in the same structures. When the outer case 47 for the left wheel 12 is used for the right wheel 13, a plug is attached to the outer end portion of the rear through hole on the lower side, and the air breather device 110 is attached to the second through hole on the upper side. In addition, in the outer case 47, the fixed brake pad 98 is retained only by the second retaining concave section 113 on the upper side among the two retaining concave sections 104, 113 for retaining the fixed brake pad 98.

According to the power transmission structure for the vehicle that is configured as described above, it is possible to further reliably prevent switching from the clutch engaged state to the clutch disengaged state when the driver does not perform the clutch operation.

### Second Embodiment

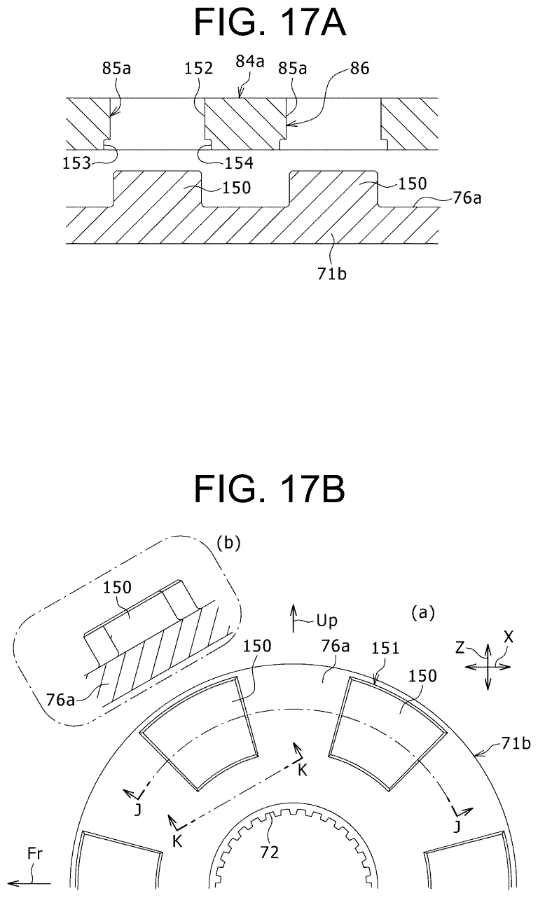

FIG. 17A is a cross-sectional view of parts of an output gear 84a and a clutch sleeve 71b in the circumferential direction and is a view illustrating a clutch disengaged state of a power transmission structure for the vehicle in another example of the embodiment. FIG. 17B (a) is a view illustrating a side surface of an upper half portion of the clutch sleeve 71b on the output gear 84a side in the other example of the embodiment. FIG. 17B (b) is a cross-sectional view that is taken along K-K in FIG. 17B (a). FIG. 17A corresponds to a cross-sectional view that is taken along J-J in FIG. 17B.

In a configuration of the present example, in a first flange 76a of the clutch sleeve 71b, a convex section 150 having a substantially trapezoidal cross section is formed at equally-spaced positions in the circumferential direction on a surface on the output gear 84a side in the axial direction. A circumferential length of each of the convex sections 150 is increased radially outward. In each of the convex sections 150, side surfaces on both sides in the radial direction are curved surfaces, each of which has an arcuate cross section centered on a center axis of the clutch sleeve 71b. The plural convex sections 150 form a convex section group 151.

Meanwhile, in the output gear 84a, plural through holes 85a, each of which can be engaged with the respective convex section 150, are provided on the surface on the clutch sleeve 71b in the axial direction. Each of the through holes 85a has a body hole section 152 and two shallow concave sections 153, 154. The body hole section 152 has a substantially trapezoidal cross section, penetrates the output gear 84a in the axial direction, and allows the engagement of the convex section 150. In the body hole section 152, the shallow concave sections 153, 154 are provided on both sides in the circumferential direction of an opening end on the clutch sleeve 71b side. The shallow concave section 153 as one of the two shallow concave sections 153, 154 is a stepped section that has the same shape as one end portion (a left end portion in FIG. 17A) in the circumferential direction of the convex section 150 and that has a substantially flat trapezoidal shape extending in the radial direction. The shallow concave section 154 as the other of the two shallow concave sections 153, 154 is a stepped section that has the same shape as the other end portion (a right end portion in FIG. 17A) in the circumferential direction of the convex section 150 and that has a substantially flat trapezoidal shape extending in the radial direction. A hole group 86 is provided by the plural through holes 85a.

An axial depth of each of the shallow concave sections 153, 154 in the output gear 84 is shallower than an axial depth of the body hole section 152 that is a different portion from the shallow concave sections 153, 154 of the through hole 85a. When the clutch sleeve 71b and the output gear 84a are in the clutch engaged state, the plural convex sections 150 each enter the body hole section 152 of respective one of the plural through holes 85a.

In the configuration of the present example, when the clutch sleeve 71b and the output gear 84a mesh with each other, the clutch sleeve 71b rotates to one side in the circumferential direction in FIG. 17A with respect to the output gear 84a from a state where the clutch sleeve 71b and the output gear 84a separate from each other as in FIG. 17A, and a portion between the adjacent through holes 85a of the output gear 84a opposes the convex section 150 of the clutch sleeve 71b in the axial direction. From this state, while the clutch sleeve 71b further rotates to the one side in the circumferential direction with respect to the output gear 84a, the clutch sleeve 71b and the output gear 84a approach each other in the axial direction. Then, the circumferential end portions of the convex section 150 are engaged with the shallow concave sections 153, 154 on the one side. In this state, an amount of relative rotation between the clutch sleeve 71b and the output gear 84a becomes small. Thus, even when backlash in the circumferential direction between the convex section 150 of the clutch sleeve 71b and the body hole section 152 of the through hole 85a in the output gear 84a is reduced, the convex section 150 and the body hole section 152 are gradually engaged in a fitted state.

The above description has been made on the case where the clutch sleeve 71b rotates to the one side in the circumferential direction in FIG. 17A with respect to the output gear 84a. However, the rotation of the clutch sleeve 71b to the other side in the circumferential direction in FIG. 17A with respect to the output gear 84a is the same as the rotation to the one side except for the rotational direction.

As a result, it is possible to reduce the backlash in the circumferential direction when the clutch sleeve 71b and the output gear 84a are engaged with each other, and it becomes easy to shift from the state where the convex section 150 of the clutch sleeve 71b opposes the portion between the through holes 85a to the meshing state. In addition, strength of each of the convex sections 150 can be increased in comparison with a structure in which each of the convex sections is formed with stepped surfaces on both sides in the circumferential direction at a tip to facilitate engagement with the hole. In the present example, the other configurations and actions are the same as those in FIGS. 1 to FIG. 16B.

### Third Embodiment

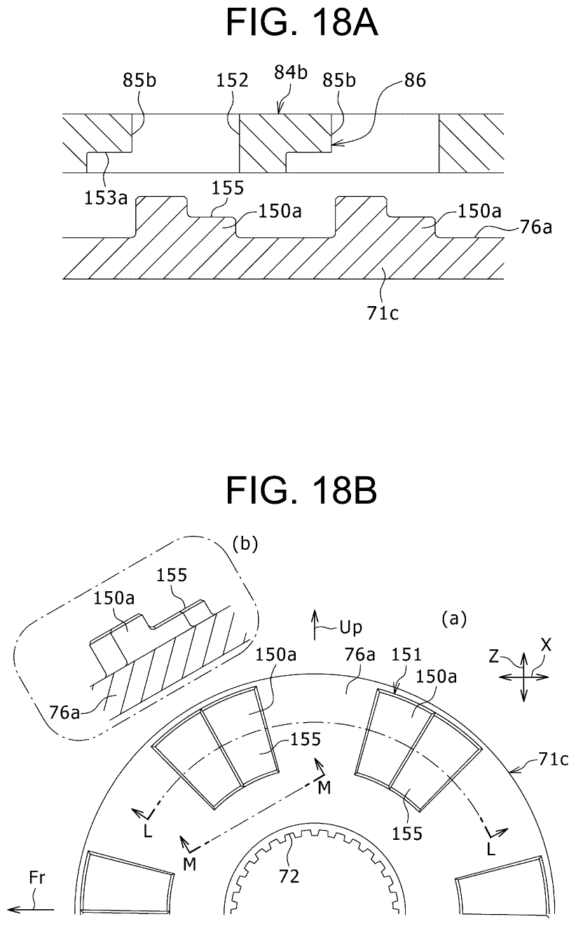

FIG. 18A is a cross-sectional view of parts of an output gear 84b and a clutch sleeve 71c in the circumferential direction and is a view illustrating a clutch disengaged state of a power transmission structure for the vehicle in further another example of the embodiment. FIG. 18B (a) is a view illustrating a side surface of an upper half portion of the clutch sleeve 71c on the output gear 84b side in further another example of the embodiment. FIG. 18B (b) is a cross-sectional view that is taken along M-M in FIG. 18B (a). FIG. 18A corresponds to a cross-sectional view that is taken along L-L in FIG. 18B.

In a configuration of the present example, a stepped section 155 is formed in the configuration of FIG. 17A and FIG. 17B. On a tip surface of each convex section 150a in the clutch sleeve 71c, the stepped section 155 is formed in the portion on the other side in the circumferential direction so as to reduce a height. In addition, each through hole 85b of the output gear 84b is provided with a shallow concave section 153a only on one end in the circumferential direction of the opening end on the clutch sleeve 71 side of the body hole section 152. A circumferential length of the shallow concave section 153a is longer than that of the shallow concave section 153 in the configuration illustrated in FIG. 17A.

In such a configuration, the convex section 150a and the body hole section 152 can easily be fitted to each other even in the case where the clutch sleeve 71c rotates to the one side in the circumferential direction with respect to the output gear 84b at an initial meshing stage, even in the case where the clutch sleeve 71c rotates to the other side in the circumferential direction with respect to the output gear 84b at the initial meshing stage, and even in the case where the backlash in the circumferential direction between the convex section 150a and the body hole section 152 of the through hole 85b is reduced.

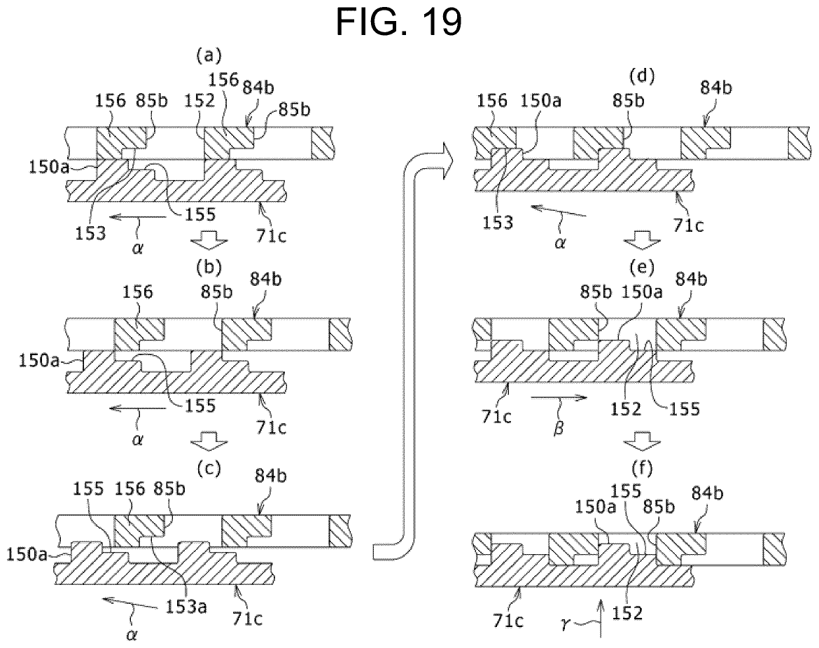

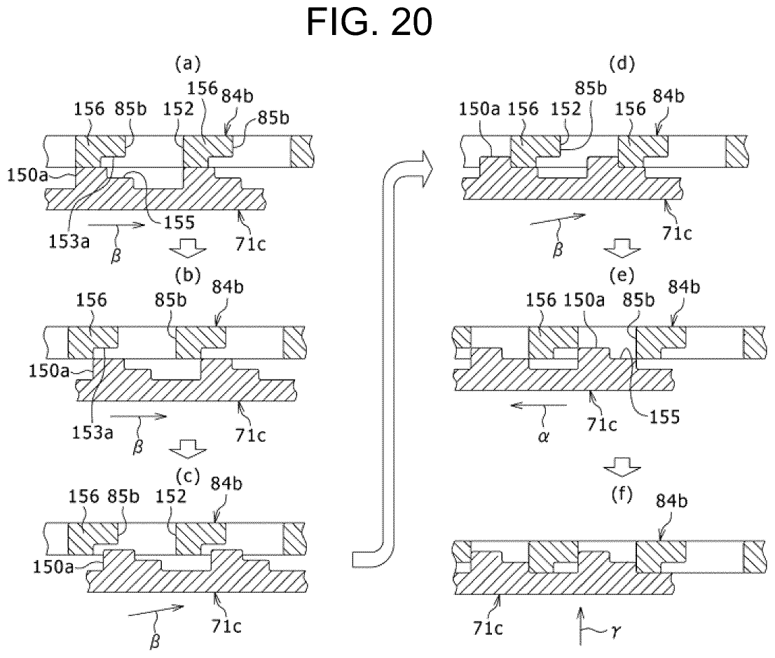

A detailed description thereon will be made with reference to FIG. 19 and FIG. 20. First, with reference to FIG. 19, a description will be made on a case where the clutch sleeve 71c rotates to one side in the circumferential direction (an arrow a direction in FIG. 19) with respect to the output gear 84b at an initial switching stage to the clutch engaged state. FIG. 19 is a view illustrating switching action from the clutch disengaged state to the clutch engaged state when the clutch sleeve 71c rotates to the one side in the circumferential direction (the arrow a direction) with respect to the output gear 84b at the initial switching stage to the clutch engaged state and is a view corresponding to FIG. 18A.

In this case, as illustrated in FIG. 19(a), when the clutch sleeve 71c approaches the output gear 84b in the axial direction, a tip of each of the convex sections 150a in the clutch sleeve 71c may abut a tip of a columnar section 156, which is located between the adjacent through holes 85b of the output gear 84b, due to a fact that the convex section 150a and the tip of the columnar section 156 are in phase with each other. Even in this case, when the clutch sleeve 71c slightly rotates in the arrow a direction, as illustrated in FIG. 19(b), the tip of each of the columnar sections 156 of the output gear 84b is displaced from the tip of the respective convex section 150a at an early stage by the stepped section 155 provided to the respective convex section 150a of the clutch sleeve 71c.

Then, as illustrated in FIG. 19(c), the clutch sleeve 71c can continuously rotate in the arrow α direction of while a tip portion of the clutch sleeve 71c is gradually fitted into the through hole 85b of the output gear 84b. Thereafter, as illustrated in FIG. 19(d), the tip portion of each of the convex sections 150a of the clutch sleeve 71c is fitted into the shallow concave section 153a of the output gear 84b and abuts the respective columnar section 156 in the circumferential direction, and the clutch engaged state is thereby established.

In the state illustrated in FIG. 19(d), the clutch sleeve 71c can rotationally move to the other side in the circumferential direction (an arrow β direction in FIG. 19(d)), but each of the convex sections 150a is fitted into the respective through hole 85b. Thus, a movable range of the clutch sleeve 71c to the other side in the circumferential direction is small. Then, as illustrated in FIG. 19(e), each of the entire convex sections 150a in the clutch sleeve 71c opposes the respective body hole section 152 of the through hole 85b. In this state, the clutch sleeve 71c is subjected to a force that is directed outward in the vehicle width direction on the basis of an operating force of the driver or the like. In this way, each of the convex sections 150a of the clutch sleeve 71c is fitted into the respective through hole 85b of the output gear 84b in an arrow γ direction, resulting in a state illustrated in FIG. 19(f).

In this case, a clearance in the circumferential direction between each of the convex sections 150a and the respective through hole 85b that are fitted to each other is small. Even in the case where the clearance is small, just as described, as illustrated in FIG. 19(c) to FIG. 19(e), the range where the clutch sleeve 71c can rotate with respect to the output gear 84b is reduced once the clutch sleeve 71c is fitted into the output gear 84b. Thus, even when the clearance is small, each of the convex sections 150a of the clutch sleeve 71c is easily fitted into the respective through hole 85b of the output gear 84b at an early stage. As a result, even when the backlash in the circumferential direction between the body hole section 152 of the through hole 85b and the convex section 150a of the clutch sleeve 71c is reduced, the convex section 150a can easily be fitted into the body hole section 152.

A description will be made on a case where the clutch sleeve 71c rotates to the other side in the circumferential direction (the arrow β direction in FIG. 20) with respect to the output gear 84b at the initial switching stage to the clutch engaged state with reference to FIG. 20. FIG. 20 is a view illustrating switching action from the clutch disengaged state to the clutch engaged state when the clutch sleeve 71c rotates to the other side in the circumferential direction (the arrow β direction) with respect to the output gear 84b at the initial switching stage to the clutch engaged state and is a view corresponding to FIG. 18A.

In this case, as illustrated in FIG. 20(a), similar to the case illustrated in FIG. 19(a), the clutch sleeve 71c approaches the output gear 84b in the axial direction, and consequently, the tip of each of the convex sections 150a in the clutch sleeve 71c may abut the tip of the respective columnar section 156. Even in this case, when the clutch sleeve 71c slightly rotates in the arrow β direction, as illustrated in FIG. 20(b), the tip of each of the columnar section 156 is displaced from the tip of the respective convex section 150a at the early stage by the shallow concave section 153a provided to the respective through hole 85b of the output gear 84b. Then, as illustrated in FIG. 20(c), the clutch sleeve 71c can continuously rotate in the arrow β direction of while the tip portion of the clutch sleeve 71c is gradually fitted into the through hole 85b of the output gear 84b. Thereafter, the tip portion of each of the convex sections 150a of the clutch sleeve 71c enters the body hole section 152 of the through hole 85b in the output gear 84b and abuts the respective columnar section 156 in the circumferential direction, and the clutch engaged state is thereby established (FIG. 20(d)).

In the state of FIG. 20(d), the clutch sleeve 71c can rotationally move to the one side in the circumferential direction (the arrow a direction in FIG. 20), but each of the convex sections 150a is fitted into the respective through hole 85b. Thus, the range where the clutch sleeve 71c can rotate to the one side in the circumferential direction is small. Then, as illustrated in FIG. 20(e), each of the entire convex sections 150a in the clutch sleeve 71c opposes the respective through hole 85b. In this state, the clutch sleeve 71c is subjected to the force that is directed outward in the vehicle width direction on the basis of the operating force of the driver or the like. In this way, each of the convex sections 150a of the clutch sleeve 71c is fitted into the respective through hole 85b of the output gear 84b in the arrow γ direction, resulting in a state illustrated in FIG. 20(f).

Also, in this case, similar to the case in FIG. 19, even in the case where the clearance in the circumferential direction is small at the time when each of the convex sections 150a is fitted into the through hole 85b, the range where the clutch sleeve 71c can rotate with respect to the output gear 84b is reduced once the clutch sleeve 71c is fitted into the output gear 84b. As a result, even when the backlash in the circumferential direction between the body hole section 152 of the through hole 85b and the convex section 150a of the clutch sleeve 71c is reduced, the convex section 150a can easily be fitted into the body hole section 152. In the present example, the other configurations and actions are the same as those in FIGS. 1 to FIG. 16B or those in FIG. 17A and FIG. 17B.

In the configuration in each of the above-described examples, the locked section is the roller 130 that can rotate on the axis thereof. However, the locked section may be structured not to rotate and to be fixed to a locking lever of a lever member. Even in this case, the power transmission structure can be configured that, when the lever member swings in the first direction about the first rotation axis, the position, which is closest to the wall surface on the gear side of the locking groove, in the locked section is made to be located away from the reference imaginary plane Pa in the first direction, and the clutch sleeve 71c can thereby be brought into the clutch engaged state. Alternatively, it can be configured that, when the lever member swings in the second direction about the first rotation axis, the position, which is closest to the wall surface, in the locked section is made to be located away from the reference imaginary plane in the second direction, and the clutch sleeve 71c can thereby be brought into the clutch disengaged state.

In the configuration in each of the above-described examples, each of the plural convex sections of the clutch sleeve is engaged with respective one of the plural through holes formed in the output gear. However, each of the through holes may be a concave section that is a hole having a closed end. Alternatively, a convex section formed in the output gear may be engaged with a through hole or a concave section formed in the clutch sleeve. For example, in the configuration in each of the examples illustrated in FIGS. 17A to FIG. 20, a convex section group having plural convex sections may be provided on an axial side surface of the output gear that opposes the clutch sleeve in the axial direction. In the clutch sleeve, a hole group having plural through holes or concave sections may be provided on an axial side surface that opposes the output gear in the axial direction.

In regard to the configuration in each of the above-described examples, the description has been made on the configuration that the left and right wheels can be driven independently of each other, the left wheel is driven by the left electric motor, and the right wheel is driven by the right electric motor. However, the present invention can also be applied to a vehicle in which left and right wheels are driven by a common electric motor.

In regard to the configuration in each of the above-described examples, the description has been made on the case where the electric motor is used as the power source for the travel motor. However, the invention can also be applied to a vehicle on which another drive source having a combination of an engine and a hydraulic transmission, or the like is mounted.

### REFERENCE SIGNS LIST

10 Vehicle
12 Left wheel
13 Right wheel
15, 16 Caster wheel
18 Lawn mower
18a to 18c Lawn mowing blade
18d Discharge duct
19 Mower deck
20 Main frame
20a, 20b Side plate section
20c Coupling section
21 Driver's seat
22, 23 Operation lever
24 Grip section
26, 27 Guide panel
30 Left travel motor (travel motor)
31 Right travel motor
32 Motor shaft
34 Battery
41, 42 Power transmission structure
43 Case
44 Transmission case
45 Brake case
46 Inner case
47 Outer case
48 Through hole
49 Cylindrical section
50, 51 Bearing
52 Hub
60 Input shaft
61 Cylindrical section
63 Deck motor
70 Clutch mechanism
71, 71a, 71b, 71c Clutch sleeve
72, 72a Clutch spline groove
74 Lever member
75 Cylindrical section
76 First flange
77 Second flange
78 Locking groove
79 Convex section
80 Gear mechanism
81 First helical gear
82 Intermediate gear shaft
83 Second helical gear
84, 84a, 84b Output gear
85, 85a Through hole
86 Hole group
90 Brake mechanism
91 Brake rotor
92 Cylindrical section
93 Rotor body
98 Fixed brake pad
99 Movable brake pad
100 Cylindrical section
101 Bearing
104, 105 Retaining concave section
106 Brake shaft
107 Brake lever
108 Cam section
109 Coil spring
110 Air breather device
111 Second through hole
112 Plug
113 Second retaining concave section
120, 121 Axle
122 Shaft spline groove
123 Large groove width portion
124 Reduced groove width portion
125 Small groove width portion
126 Gear section
130 Roller
132 Urging member
133 Snap ring
135 Operation tool
137 Lever shaft
139 Locking lever
140 Hole
141 Shaft section
142 Second stopper
144 Detent mechanism
145 Concave section
146 Ball
148 Urging member
149 Lateral hole
150, 150a Convex section
151 Convex section group
152 Body hole section
153, 154 Shallow concave section
155 Stepped section
156 Columnar section

1. A power transmission structure for a vehicle comprising:
an axle that directly or indirectly drives a ground wheel;
a gear that is fitted to a radially outer side of the axle in a relatively rotatable manner and receives power used to drive the ground wheel;
a clutch sleeve that is adjacent to the gear and is fitted to the axle in a manner not to rotate relative thereto and to be freely slidable in an axial direction; and
a lever member that causes the clutch sleeve to reciprocate in the axial direction,
the power transmission structure for a vehicle being provided with a hole and a convex section as meshing elements capable of meshing with each other between opposing surfaces of the gear and the clutch sleeve and switching to enable or disable power transmission between the gear and the axle by movement of the clutch sleeve, wherein
a locking groove is formed on an entire circumference of an outer circumferential surface of the clutch sleeve,
the lever member includes a lever shaft, a locking lever, and a locked section, the lever shaft can rotate about a first rotation axis, which is orthogonal to an axle parallel line parallel to a center axis of the axle, and is fixed with an operation device, the locking lever is provided in one end portion of the lever shaft and extends in a direction orthogonal to the first rotation axis, and the locked section is provided at a position away from the first rotation axis of the locking lever and is locked to the locking groove,
a reference imaginary plane that includes the axle parallel line starting from the first rotation axis is defined, and
when the lever member swings in a first direction about the first rotation axis, a position, which is closest to a wall surface on the gear side of the locking groove, in the locked section is made to be located away from the reference imaginary plane in the first direction, thereby resulting in a clutch engagement state in which the clutch sleeve can mesh with the gear via the meshing element, and when the lever member swings in a second direction about the first rotation axis, the position closest to the wall surface in the locked section is made to be located away from the reference imaginary plane in the second direction, thereby resulting in a clutch disengaged state where the clutch sleeve separates from the gear in the axial direction.

2. The power transmission structure for a vehicle according to claim 1, wherein
the locked section is a roller that is provided at a position away from the first rotation axis of the locking lever, can rotate about a second rotation axis that is parallel to the first rotation axis, and is locked to the locking groove.

3. The power transmission structure for a vehicle according to claim 1 further comprising:
a case that accommodates the axle, the gear, the clutch sleeve, and the lever member, wherein
the case is provided with a stopper that directly or indirectly inhibits movement of the lever member in order to prevent the lever member from further swinging in the first direction when the locked section is located on the first direction side from the reference imaginary plane for clutch engagement.

4. The power transmission structure for a vehicle according to claim 1, wherein
a shaft spline groove and a clutch spline groove are spline-engaged with each other, the shaft spline groove is provided on an outer circumferential surface of the axle, and the clutch spline groove is provided on an inner circumferential surface of the clutch sleeve, and
the shaft spline groove has a reduced groove width portion, a groove width of which is reduced toward an opposite side from a side where the gear is installed in the axial direction.

5. The power transmission structure for a vehicle according to claim 1, wherein
in one of the clutch sleeve and the gear, an axial side surface that opposes the other in the axial direction is provided with a convex section group,
in the other of the clutch sleeve and the gear, an axial side surface that opposes the one in the axial direction is provided with a hole group,
each of the holes in the hole group is provided with a shallow concave section at least at one end in a circumferential direction, and a depth in the axial direction of the shallow concave section is shallower than a depth in the axial direction of a portion other than the shallow concave section of the hole, and
when the clutch sleeve and the gear are in the clutch engaged state, each of the plural convex sections enters a portion of respective one of the plural holes, the portion having a depth in the axial direction that is deeper than the shallow concave section.
